(19) United States
(12) Patent Application Publication
(10) Pub. No.: US 2023/0004208 A1
(43) Pub. Date: Jan. 5, 2023

(54) INDUCED CURRENT-BASED POWER SUPPLY CONTROL

(71) Applicant: HEWLETT-PACKARD DEVELOPMENT COMPANY, L.P., Spring, TX (US)

(72) Inventor: Cheng-Yan Chiang, Taipei City (TW)

(73) Assignee: HEWLETT-PACKARD DEVELOPMENT COMPANY, L.P., Spring, TX (US)

(21) Appl. No.: 17/782,884

(22) PCT Filed: Dec. 6, 2019
(86) PCT No.: PCT/US2019/064927

§ 371 Date: Jun. 6, 2022

(51) Int. Cl. G06F 1/3246; G06F 1/3287

(52) U.S. Cl. CPC G06F 1/3246; G06F 1/3287

(57) ABSTRACT

In one example, an electronic device may include an electronic switch connected to a power supply, a controller connected to the electronic switch, an electromagnetic generator connected to the controller, and a power button coupled to the electro-magnetic generator. The electromagnetic generator may generate an induced current when the power button is pressed. Further, the controller may receive the induced current and output a control signal to the electronic switch to enable the electronic switch to control the power supply to the electronic device.

### BACKGROUND

Portable computers are compact, lightweight computing devices and may include any portable electronic device, for example, notebook computers, personal digital assistants, tablet personal computers, laptop computers, and the like. Portable computers may be provided with a power button to turn a power supply on and off. The power buttons may provide input to a controller. The controller can control the power supply when the power button is triggered. For example, when the power button is pressed, the controller may provide the power supply to execute a booting procedure of the portable computers.

### BRIEF DESCRIPTION OF THE DRAWINGS

Examples are described in the following detailed description and in reference to the drawings, in which:

FIG. 1A is a block diagram of an example electronic device, including a controller to control power supply to the electronic device;

FIG. 1B is a block diagram of the example electronic device of FIG. 1A, depicting additional features;

FIG. 2A is a block diagram of an example, electronic device, including a controller that utilizes an induced current to execute a booting process of the electronic device:

FIG. 2B is a schematic diagram of the example electronic device of FIG. 2A, depicting additional features; and

FIG. 3 is an example flow diagram for controlling power supply to an electronic device by utilizing an induced electrical current.

### DETAILED DESCRIPTION

Electronic devices may be provided with power buttons to turn power supply on and off. The power buttons may interface with a controller (e.g., a chipset) to provide an input to the controller. For example, a button press event may trigger an interrupt to the controller. Then, the controller may control the power supply to the electronic device upon detecting the button press event. In this example, the controller may detect the button press event and output a control signal to supply power, for instance, for booting the electronic device.

The controllers may be used in various low-power and/or battery-powered applications, such as notebook computers, tablet computers, smartphones, MP3 players, video game consoles, and the like. The lifetime of batteries in such applications may depend on the power consumption of components of the electronic device. For example, a controller in such an electronic device may be in a turn-on state (i.e., working) when the electronic device is in a power-off mode. In this example, the controller may be in an active or turn-on state to monitor the power button and detect the power button input (i.e., the button press event) while the electronic device is in the power-off mode, For example, the power button input may be generated by pressing the power button.

In such examples, the controller may consume power (e.g., about 0.3 W) while waiting for a signal from the power button during the power-off mode of the electronic device. The controller may spend substantial amount of time inactive and wait for the signal from the power button by consuming a significant amount of battery power. Thus, the controller may consume the battery power of the electronic device even when the electronic device is in the power-off mode.

Examples described herein may provide an electromagnetic generator coupled to a power button. The, electromagnetic generator may generate an induced current when the power button is pressed. In this example, the electromagnetic generator may convert the kinetic energy (e,g, of the power button) into electrical energy (e.g., induced current) in accordance with Faraday's law of induction. The electromagnetic generator may supply the induced current to a controller to power on the controller. The controller, when powered on, may output a control signal to an electronic switch to enable the electronic switch to control the power supply to the electronic device. Thus, examples described herein may use the induced current (i.e., magnetically generated power) to enable the controller to generate a control signal for controlling the power supply to the electronic device. During the power off mode (i.e., a shutdown mode) of the electronic device, the controller may not consume the battery power of the electronic device. Thus, examples described herein may facilitate zero power consumption in the power off mode of the electronic device.

In the following description, for purposes of explanation, numerous specific details are set forth in order to provide a thorough understanding of the present techniques. Further, the example apparatuses, devices, and systems described herein may be practiced without these specific details. Reference in the specification to “an example” or similar language means that a particular feature, structure, or characteristic described is included in at least that one example, but not necessarily in other examples.

Turning now to the figures, FIG, 1A is a block diagram of an example electronic device 100, including a controller 106 to control power supply to electronic device 100. Example electronic device 100 may include a notebook, tablet, personal computer (PC), smartphone, gaming laptop, workstation, or the like.

Example electronic device 100 may include an electronic switch 102 connected to a power supply 104. In one example, electronic switch 102 may include an input terminal electrically connected to power supply 104, an output terminal to provide power to components (e.g., a processor, memory, and the like) of electronic device 100, and a control terminal connected to controller 106. Example electronic switch 102 may be a transistor having a gate terminal serving as the control terminal, a source terminal connected to the components for supplying the power, and a drain terminal connected to power supply 104. Power supply 104 may provide power to operate electronic device 100. Example power supply 104 may be a DC power supply such as a battery.

Further, electronic device 100 may include controller 106 connected to electronic switch 102. Controller 106 may be used to turn power supply 104 on or off via electronic switch 102. Controller 106 may be implemented in hardware, machine-readable instructions, or a combination thereof. For example, controller 106 may be implemented as engines or modules including any combination of hardware and programming to implement the functionalities described herein. For example, controller 106 can be implemented with a microcontroller, an application-specific integrated circuit (ASIC), a programmable gate array (PGA), or any other type of hardware component having access to the firmware (e.g., BIOS, REFI, or the like) stored in electronic device 100. Example controller 106 may be an embedded controller, super I/O chip, a control integrated circuit (IC) chip, or any other controller chip in electronic device 100.

During operation, controller 106 may control a power state of electronic device 100 via electronic switch 102. For example, controller 106 may provide a control signal to the control terminal of electronic switch 102 to control the power to electronic device 100. Furthermore, electronic device 100 may include an electromagnetic generator 108 electrically connected to controller 106. In one example, controller 106 may include an input terminal connected to electromagnetic generator 108 and an output terminal connected to electronic switch 102 to control power supply 104. Also, electronic device 100 may include a power button 110 coupled to electromagnetic generator 108 to power on electronic device 100. During operation, electromagnetic generator 108 may convert kinetic energy (e.g., of power button 110) into electrical energy (e.g., induced current) in accordance with Faraday's law of induction.

In one example, power button 110 may refer to a switch that may be pressed down and released to power electronic device 100 on or off. Electromagnetic generator 108 may generate the induced current (i.e., electromotive force) when power button 110 is pressed and supply the induced current to controller 106 to power on controller 106. In some examples, controller 106 may receive a power button signal along with the induced current when power button 110 is pressed. For example, the power button signal may be used to turn on power supply 104 to electronic device 100 that is in an off state. Further, controller 106 may receive the induced current and output the control signal to electronic switch 102 to enable electronic switch 102 to control power supply 104 to electronic device 100 (e.g., as shown by arrow 112).

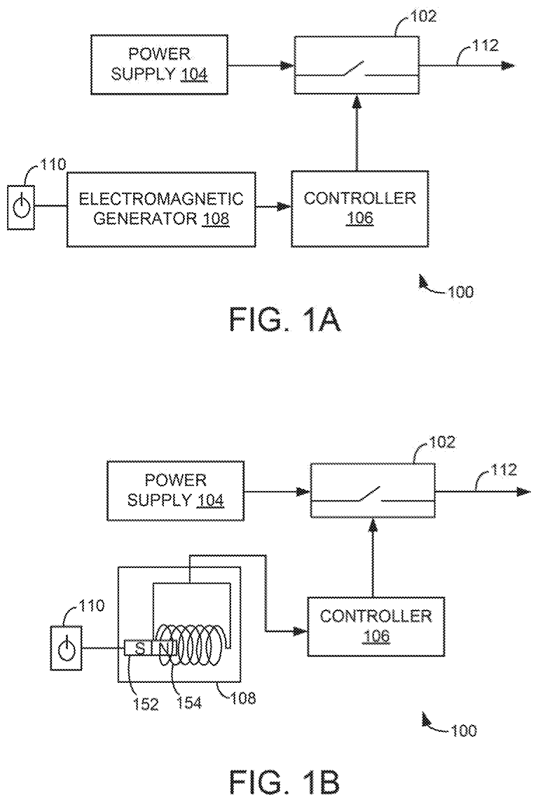

FIG. 1B is a block diagram of example electronic device 100 of FIG. 1A, depicting additional features. For example, similarly named elements of FIG. 1B may be similar in structure and/or function to elements described with respect to FIG. 1A. As shown in FIG, 1B, electromagnetic generator 108 may include a magnet 152 mechanically coupled to power button 110. In this example, magnet 152 may move along with power button 110, for instance, when power button 110 is pushed. Example magnet 152 may be a permanent magnet.

Further, electromagnetic generator 108 may include a coil 154 disposed relative to magnet 152. Example coil 154 may include an induction wire. Example induction wire may be a copper wire. In the example shown in FIG. 1B, coil 154 may be coiled around a north pole of magnet 152. Coil 154 may be electrically connected to controller 106. During operation, power button 110, when pressed, may move magnet 152 relative to coil 154 to generate the induced current in coil 154, for instance, by electromagnetic induction (e.g., in adherence to principles of Faraday's law of induction). Further, coil 154 may supply the induced current to controller 106 to output the control signal to electronic switch 102.

In one example, controller 106, upon receiving the induced current, may output the control signal to electronic switch 102 to boot electronic device 100. In another example, controller 106 may output the control signal used to execute a shutdown process in electronic device 100 when electronic device 100 is in a power-on mode and power button 110 is pressed and held for a defined time value (e.g., 4 seconds). In yet another example, controller 106 may output the control signal used to place electronic device 100 in a power-saving mode when electronic device 100 is in the power-on mode and power button 110 is momentarily pressed. Thus, examples described herein may facilitate controller 106 to use the magnetically generated power from electromagnetic generator 1 08 for controlling power supply 104 to electronic device 100.

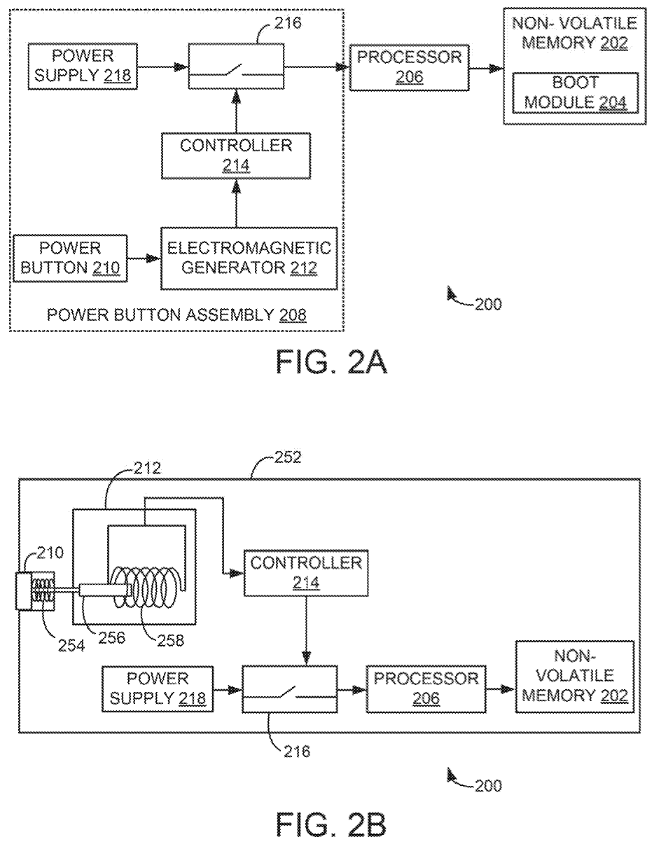

FIG. 2A is a block diagram of an example electronic device 200, including a controller 214 that utilizes an induced current to execute a booting process of electronic device 200. Example electronic device 200 may include a non-volatile memory 202 storing a boot module 204, and a processor 206 coupled to non-volatile memory 202. Non-volatile memory 202 may be a non-volatile machine-readable storage medium such as any electronic, magnetic, optical, or other physical storage device that can retain the stored information even when not powered. Example non-volatile memory 202 may be a non-volatile random-access memory (NVRAM), a read-only memory (ROM), a flash memory, or the like. Processor 206 may be any type of central processing unit (CPU), microprocessor, or processing logic that interprets and executes machine-readable instructions stored in non-volatile memory 202 or any machine-readable storage medium.

In some examples, boot module 204 may be a boot firmware used to execute the booting process of electronic device 200 to load an operating system into memory of electronic device 200 when electronic device 200 is booted and then start the operating system. The booting process may be initially controlled by boot module 204 stored in non-volatile memory 202. For example, when electronic device 200 is started or powered on, boot module 204 may provide processor 206 with an initial set of instructions to configure hardware and programming of electronic device 200. Example boot module 204 may be a basic input/output system (BIOS), unified extensible firmware interface (UEFI), or the like.

Further, electronic device 200 may include a power button assembly 208 coupled to processor 206. In one example, power button assembly 208 may include a power button 210 and an electromagnetic generator 212 coupled to power button 210. Electromagnetic generator 212 may generate an induced current when power button 210 is pressed.

Furthermore, electronic device 200 may include controller 214 electrically connected to electromagnetic generator 212 to receive the induced current and output a first control signal. In this example, the induced current may be used to power on or activate controller 214 and to generate the first control signal when electronic device 200 is in a power-off mode and power button 210 is pressed. Also, electronic device 200 may include an electronic switch 216 connected to controller 214 and a power supply 218. For example, electronic device 200 may include a battery to provide power supply 218. In some examples, electronic switch 216 may include an input terminal electrically connected to power supply 218, an output terminal electrically connected to processor 206, and a control terminal connected to controller 214.

During operation, controller 214 may receive induced current and output the first control signal to electronic switch 216 to turn on electronic switch 216. Further, electronic switch 216, upon turning on, may provide power supply 218 to processor 206 so that processor 206 can execute boot module 204 to boot electronic device 200. In this example, processor 206 may first execute boot module 204 to perform tasks such as performing power-on self-test (POST), detecting hardware, installing drivers, and loading in an operating system. Boot module 204 may then give control of electronic device 200 to the operating system.

In another example, controller 214 may output a second control signal to electronic switch 216 to place electronic device 200 in a power-saving mode or in a shut-down mode when electronic device 200 is in a power-on mode and power button 210 is pressed. Example power-saving mode may include a standby mode or a hibernation mode. In some examples, controller 214 may generate the first control signal and the second control signal in accordance with a control logic (e.g., a policy defined in controller 214) to control power supply 218 to the electronic device.

FIG, 2B is a schematic diagram of example electronic device 200 of FIG. 2A, depicting additional features. For example, similarly named elements of FIG. 26 may be similar in structure and/or function to elements described with respect to FIG. 2A. As shown in FIG. 26, electronic device 200 may include a housing 252 to house non-volatile memory 202, processor 206, and power button assembly 208 (e.g., as shown in FIG. 2A). Example housing 252 may include an opening to receive power button 210.

Further, power button assembly 208 may include an elastic member 254 connecting power button 210 to housing 252. For example, elastic member 254 may restore power button 210 to an original position upon releasing power button 210 (i.e., when an external force applied on power button 210 is removed).

Furthermore, electromagnetic generator 212 may include a magnet 256 mechanically coupled to power button 210 and movable with power button 210. Also, electromagnetic generator 212 may include a coil 258 surrounding magnet 256 and electrically connected to controller 214. During operation, power button 210, when pressed by a user, may move magnet 256 relative to coil 258 to generate the induced current in coil 258. As shown in FIG. 2B, magnet 256 and coil 258 may be positioned such that magnet 256 may move along with power button 210 in an axial direction of coil 258. For example, magnet 256 may move freely in the coil plane within boundaries of housing 252. In this example, movement of power button 210 may induce sliding of magnet 256 in a sliding plane parallel to the coil plane, thereby causing a change in magnetic flux through coil 258 and inducing a voltage/current across coil 258.

Electronic devices 100 and 200 of FIGS. 1A, 1B, 2A, and 2B may include computer-readable storage medium including (e.g., encoded with) instructions executable by a processor to implement functionalities described herein in relation to FIGS. 1A, 1B, 2A, and 2B. In some examples, the functionalities described herein, in relation to instructions to implement functions of components of electronic device 100 or 200 and any additional instructions described herein in relation to the storage medium, may be implemented as engines or modules including any combination of hardware and programming to implement the, functionalities of the modules or engines described herein. The functions of components of electronic device 100 or 200 may also be implemented by a respective processor,

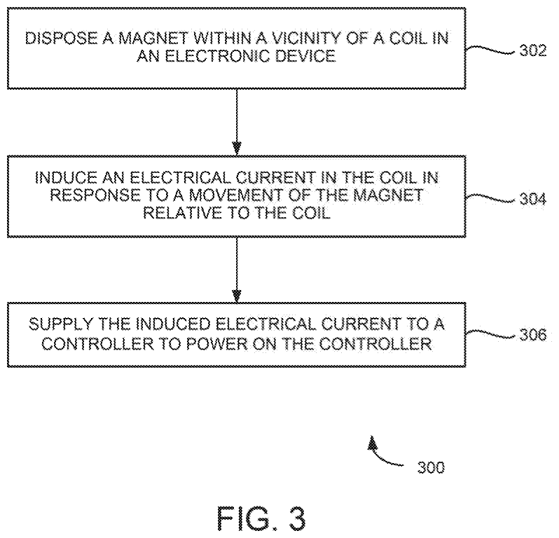

FIG. 3 is an example flow diagram 300 for controlling power supply to an electronic device by utilizing an induced electrical current. It should be understood that the process depicted in FIG. 3 represents generalized illustrations, and that other processes may be added, or existing processes may be removed, modified, or rearranged without departing from the scope and spirit of the present application. In addition, it should be understood that the processes may represent instructions stored on a computer-readable storage medium that, when executed, may cause a processor to respond, to perform actions, to change states, and/or to make decisions. Alternatively, the processes may represent functions and/or actions performed by functionally equivalent circuits like analog circuits, digital signal processing circuits, application specific integrated circuits (ASICs), or other hardware components associated with the system. Furthermore, the flow charts are not intended to limit the implementation of the present application, but rather the flow charts illustrate functional information to design/fabricate circuits, generate machine-readable instructions, or use a combination of hardware and machine-readable instructions to perform the illustrated processes.

At 302, a magnet may be disposed within a vicinity of a coil in the electronic device. In one example, the magnet may be mechanically coupled to a power button of the electronic device and movable with the power button At 304, an electrical current may be induced in the coil in response to a movement of the magnet relative to the coil. In this example, mechanically moving the magnet may provide a free movement of the magnet in a plane parallel to the coil plane.

At 306, the induced electrical current may be supplied to a controller to power on the controller, In one example, the induced electrical current may be supplied to the controller via an electrical connection between the controller and the, coil. The electrical connection may be formed by connecting electrical ends of the coil to electrical contacts of the controller.

The controller, upon powering on, may output a control signal in accordance with a control logic to control the power supply to the electronic device. In one example, the controller may output the control signal to an electronic switch to turn on the electronic switch, The electronic switch, upon turning on, may enable the power supply to execute an initialization process of the electronic device. In other examples, the controller may provide the control signal to a central processing unit (CPU) of the electronic device to perform the initialization process when the electronic device is booted.

In the examples described in FIGS. 1A, 1B, 2A, 2B, and 3, the magnet is shown as being coupled to the power button and movable relative to the coil, however, in other examples, the coil can be coupled to the power button and movable relative to the magnet. In this example, the coil may move with the power button while the magnet is fixedly disposed in the electronic device.

It may be noted that the above-described examples of the present solution are for the purpose of illustration only. Although the solution has been described in conjunction with a specific implementation thereof, numerous modifications may be possible without materially departing from the teachings and advantages of the subject matter described herein. Other substitutions, modifications and changes may be made without departing from the spirit of the present solution. All of the features disclosed in this specification (including any accompanying claims, abstract, and drawings), and/or all of the steps of any method or process so disclosed, may be combined in any combination, except combinations where at least some of such features and/or steps are mutually exclusive.

The terms “include,” “have,” and variations thereof, as used herein, have the same meaning as the term “comprise” or appropriate variation thereof. Furthermore, the term “based on”, as used herein, means “based at least in part on.” Thus, a feature that is described as based on some stimulus can be based on the stimulus or a combination of stimuli including the stimulus.

The present description has been shown and described with reference to the foregoing examples. It is understood, however, that other forms, details, and examples can be made without departing from the spirit and scope of the present subject matter that is defined in the following claims.

What is claimed is:

1. An electronic device comprising:
an electronic switch connected to a power supply;
a controller connected to the electronic switch;
an electromagnetic generator connected to the controller; and
a power button coupled to the electromagnetic generator, wherein the electromagnetic generator is to generate an induced current when the power button is pressed, and wherein the controller is to receive the induced current and output a control signal to the electronic switch to enable the electronic switch to control the power supply to the electronic device.

2. The electronic device of claim 1, wherein the electromagnetic generator comprises:
a magnet mechanically coupled to the power button and moves with the power button; and
a coil disposed relative to the magnet and electrically connected to the controller, wherein the power button, when pressed, is to move the magnet relative to the coil to generate the induced current in the coil, and wherein the coil is to supply the induced current to the controller to output the control signal.

3. The electronic device of claim 1, wherein the controller is to output the control signal to the electronic switch, upon receiving the induced current, to boot the electronic device.

4. The electronic device of claim 1, wherein the controller is to output the control signal used to execute a shutdown process in the electronic device when the electronic device is in a power-on mode and the power button is pressed and held for a defined time value.

5. The electronic device of claim 1, wherein the controller is to output the control signal used to place the electronic device in a power-saving mode when the electronic device is in a power-on mode and the power button is pressed.

6. An electronic device comprising:
a non-volatile memory storing a boot module;
a processor coupled to the non-volatile memory; and
a power button assembly coupled to the processor, the power button assembly comprising:
a power button;
an electromagnetic generator coupled to the power button, wherein the electromagnetic generator is to generate an induced current when the power button is pressed;
a controller electrically connected to the electromagnetic generator to receive the induced current and output a first control signal; and
an electronic switch connected to the controller and a power supply, wherein the controller is to output the first control signal to the electronic switch to turn on the electronic switch, and wherein the electronic switch, upon turning on, is to provide the power supply to the processor to execute the boot module to boot the electronic device.

7. The electronic device of claim 6, further comprising:
a housing to house the non-volatile memory, the processor, and the power button assembly, wherein the housing comprising an opening to receive the power button.

8. The electronic device of claim, wherein the power button assembly comprises:
an elastic member connecting the power button to the housing, wherein the elastic member is to restore the power button to an original, position upon releasing the power button,

9. The electronic device of claim 6, wherein the electromagnetic generator comprises:
a magnet mechanically coupled to the power button and movable with the power button; and
a coil surrounding the magnet and electrically connected to the controller, wherein the power button, when pressed, is to move the magnet relative to the coil to generate the induced current in the coil.

10. The electronic device of claim 9, wherein the magnet and the coil are positioned such that the magnet is to move with the power button in an axial direction of the coil.

11. The electronic device of claim 6, wherein the controller is to output a second control signal to the electronic switch to place the electronic device in a power-saving mode or in a shut-down mode when the electronic device is in a power-on mode and the power button is pressed, and wherein the power-saving mode comprises a standby mode or a hibernation mode.

12. The electronic device of claim 6, further comprising a battery to provide the power supply.

13. A method for controlling power supply to an electronic device, comprising:
disposing a magnet within a vicinity of a coil in the electronic device, wherein the magnet is mechanically coupled to a power button of the electronic device and movable with the power button:
inducing an electrical current in the coil in response to a movement of the magnet relative to the coil, wherein the magnet is to move relative to the coil when the power button is pressed; and
supplying the induced electrical current to a controller to power on the controller, wherein the controller, upon powering on, is to output a control signal in accordance with a control logic to control the power supply to the electronic device.

14. The method of claim 13, wherein the controller is to output the control signal to an electronic switch to turn on the electronic switch, wherein the electronic switch, upon turning on, enables the power supply to execute an initialization process of the electronic device.

15. The method of claim wherein supplying the induced electrical current to the controller comprises:
supplying the induced electrical current to the controller via an electrical connection between the controller and the coil, wherein the electrical connection is formed by connecting electrical ends of the coil to electrical contacts of the controller.
